(19) United States
(12) Patent Application Publication
(10) Pub. No.: US 2011/0066537 A1
(43) Pub. Date: Mar. 17, 2011

(54) IMPLIED VOLUME ANALYZER

(76) Inventors: Andrew Milne, Maplewood, NJ (US); Aleksandr Sedlin, Brooklyn, NY (US); Vladimir Feldman, Fair Lawn, NJ (US); Paul Callaway, Chicago, IL (US); Pearce Peck-Walden, Chicago, IL (US); Mark Robinson, Oak Park, IL (US)

(21) Appl. No.: 12/560,145

(22) Filed: Sep. 15, 2009

(51) Int. Cl. G06Q 40/00

(52) U.S. Cl. 705/37

(57) ABSTRACT

A volume analyzer is provided. The volume analyzer includes an input, a processor, and an output. The input is operable to receive market data and a calculation policy. The processor is coupled with the input. The processor is operable to identify an available implied pattern based on the market data and the calculation policy. The available implied pattern has not been calculated by a match engine. The output is coupled with the processor. The processor is operable to provide the available implied pattern to the output.

### RELATED APPLICATIONS

This application is related to U.S. patent application Ser. No. 10/700,406, filed Nov. 4, 2003, which is incorporated herein by reference in its entirety.

This application is related to U.S. patent application Ser. No. 11/368,966, filed Mar. 6, 2006, which is a division of U.S. patent application Ser. No. 09/971,172, filed on Oct. 4, 2001, all of which are incorporated herein by reference in its entirety.

This application is related to U.S. patent application Ser. No. 12/032,379, filed Feb. 15, 2008, which is incorporated herein by reference in its entirety.

This application is related to U.S. patent application Ser. No. 12/350,788, filed Jan. 8, 2009, which is incorporated herein by reference in its entirety.

This application is related to U.S. patent application Ser. No. [Attorney/Docket 4672-733], filed Sep. 11, 2009, which is incorporated herein by reference in its entirety.

This application is related to U.S. patent application Ser. No. [Attorney/Docket 4672-734], filed on ______, which is incorporated herein by reference in its entirety.

This application is related to U.S. patent application Ser. No. [Attorney/Docket 4672-737], filed on ______, which is incorporated herein by reference in its entirety.

This application is related to U.S. patent application Ser. No. [Attorney/Docket 4672-738], filed ______, which is incorporated herein by reference in its entirety.

### BACKGROUND

Electronic trading systems allow entry of a bid or offer for a particular tradable item, which in futures trading is referred to as a contract. The simplest possible futures contract is the outright contract defined by a product and a delivery period. It is also possible to define contracts that are combinations of simpler contracts. For example, the spread contract is defined as the simultaneous purchase and sale of two tradable items, such as futures contracts for different months, different commodities, or different grades of the same commodity. The bid and offer components of a spread are termed the bid leg and the offer leg respectively.

Electronic trading systems accept bids and offers in the form of orders, also referred to as real orders because they consist of data entered by traders either directly or by computing devices under their control. Real orders may be entered for any tradable item in the system. Implied orders, unlike real orders, are generated by the system on the behalf of traders who have entered real orders, generally with the purpose of increasing overall market liquidity. For example, an implied spread may be derived from two real outrights. Trading systems create the “derived” or “implied” order and display the market that results from the creation of the implied order as a market that may be traded against. If a trader enters an order to trade against this implied market, then the newly entered order and the real orders that were used to derive the implied market are executed as matched trades.

Implied orders may be calculated from straightforward combinations of orders in outright contracts and orders in combination contracts such as spreads. However, implied orders can also be calculated using orders from more complex combination contracts such as strips, butterfly spreads, condor spreads, multi-leg crack spreads, straddles, and strangles. In general, a combination contract, also referred to as a strategy, can consist of any number of buy and sell legs for other contracts. Any number of real orders for outrights and strategies can in principle be combined to form an implied order.

The possible combinations of real orders that can form implied orders may be grouped into patterns according to the types of contracts that appear in the combination. For example, the generic combination of any two outrights implying a spread is a pattern. The generic combination of two outrights and a spread implying a spread is also a pattern. The number of specific combinations of contracts associated with each pattern depends on the number of contract types in the pattern and the number of contracts of that type that exist in the trading system.

Implied orders frequently have better prices than the corresponding real orders in the same contract. This can occur when two or more traders incrementally improve their order prices in hope of attracting a trade, since combining the small improvements from two or more real orders can result in a big improvement in their combination. In general, advertising implied orders at better prices will encourage traders to enter the opposing orders to trade with them. The more combinations that the match engine can calculate, the greater this encouragement will be and the more the owners of the trading system will benefit from increased transaction volume.

However, as the number of advertised orders increases, so does the time required to calculate and publish them as market data. Trading systems do not have an efficient method of identifying all possible or best possible implied markets, nor do they have a reproducible and quantitative means of identifying which patterns would be likely to result in trades. Trading systems only a few simple implied patterns are calculated and then only for a small number of heavily traded contracts. Identifying the most profitable of the longer and more complex patterns through implied volume analysis can bring additional revenue to the owners of the system.

### BRIEF DESCRIPTION OF THE DRAWINGS

FIG. 1 illustrates one embodiment of a trading network;

FIG. 2 illustrates one embodiment of a match engine module;

FIG. 3 illustrates a volume analyzer;

FIG. 4 illustrates one embodiment of a volume analyzer module coupled with a match engine module, market data module, and external market data server;

FIG. 5 illustrates one embodiment of a group of available implied patterns;

FIG. 6 illustrates one embodiment of a method for outputting available implied patterns;

FIG. 7 illustrates one embodiment of a method for identifying available implied patterns;

FIG. 8 illustrates another embodiment of a method for identifying available implied patterns;

FIG. 9 illustrates one embodiment of a trading network including a volume analyzer and visualize;

FIG. 10 illustrates one embodiment of market data;

FIG. 11 illustrates one embodiment of an output representation of an available implied pattern; and

FIG. 12a and FIG. 12b show windows displayed by a visualizer for implied spreads between Minneapolis Hard Red Spring Wheat MWE and Chicago Board of Trade (CBOT) Wheat ZW.

### DETAILED DESCRIPTION

The present embodiments relate to implied volume analysis. Implied volume analysis relates to identifying implied markets in available implied patterns. As used herein, the term “available implied pattern” includes implied patterns that could be made available to traders. In other words, one or more outright orders and/or implied orders have been identified such that the implied pattern could be calculated and made available to a trader. Available implied patterns are implied patterns that have not been calculated.

In one embodiment, an electronic trading system includes a match engine and an implied volume analyzer. The match engine receives outright orders, stores them internally, calculates tradable combinations, and advertises the presence of real and implied orders in the form of market data. When the traders using the system respond to the market data by sending outright orders, these are received by the match engine, which then attempts to match them with previously received orders or combinations thereof The match engine executes the possible trades and communicates the results. The implied volume analyzer may be independent of the match engine, for example, in order to preserve processing cycles or memory. The implied volume analyzer may identify implied markets in available implied patterns. In other words, the implied volume analyzer is operable to calculate implied markets in the implied patterns that have not been calculated by the match engine, for example, based on the market data and received orders. The available implied markets may be fed back into the design of the match engine, such that the match engine may calculate implied markets in these implied patterns in the future. Alternatively, the implied markets that can be calculated for a given set of available implied patterns may be displayed, for example, on a monitor.

One benefit of using the implied volume analyzer is that the electronic trading system is now operable to identify, without using the match engine's processing cycles or memory, implied patterns that are not being calculated by the match engine. This is advantageous because the match engine is able to continue quickly matching orders and the electronic trading system is operable to identify missed opportunities. By identifying the missed opportunities, the exchange may identify areas of potential revenue.

In one aspect, a volume analyzer is provided. The volume analyzer includes an input, processor, and output. The input is operable to receive market data and a calculation policy. The processor is coupled with the input. The processor is operable to identify an available implied pattern based on the market data and the calculation policy, the available implied pattern having not been calculated by a match engine. The output is coupled with the processor. The processor is operable to provide the available implied pattern to the output.

In another aspect, a method for analyzing implied volumes is provided. The method includes receiving market data and at least one calculation policy; identifying a non-utilized implied pattern based on the market data and the calculation policy, the non-utilized implied pattern having an implied pattern volume that satisfies a volume level; and outputting the non-utilized implied pattern.

In yet another aspect, a system is provided. The system includes a bus system operable to transmit and receive market data; a memory operable to store a calculation policy; a volume analyzer coupled with the bus system and memory. The volume analyzer is operable to obtain market data from the bus system and the calculation policy from the memory, identify a non-utilized implied pattern based on the market data and the calculation policy, the non-utilized implied pattern having an implied pattern volume that satisfies a volume level, and output the non-utilized implied pattern to the bus system or memory.

In yet another aspect, a device is provided. The device includes means for receiving market data and at least one calculation policy; means for identifying a non-utilized implied pattern based on the market data and the calculation policy, the non-utilized implied pattern having an implied pattern volume that satisfies a volume level; and means for outputting the non-utilized implied pattern.

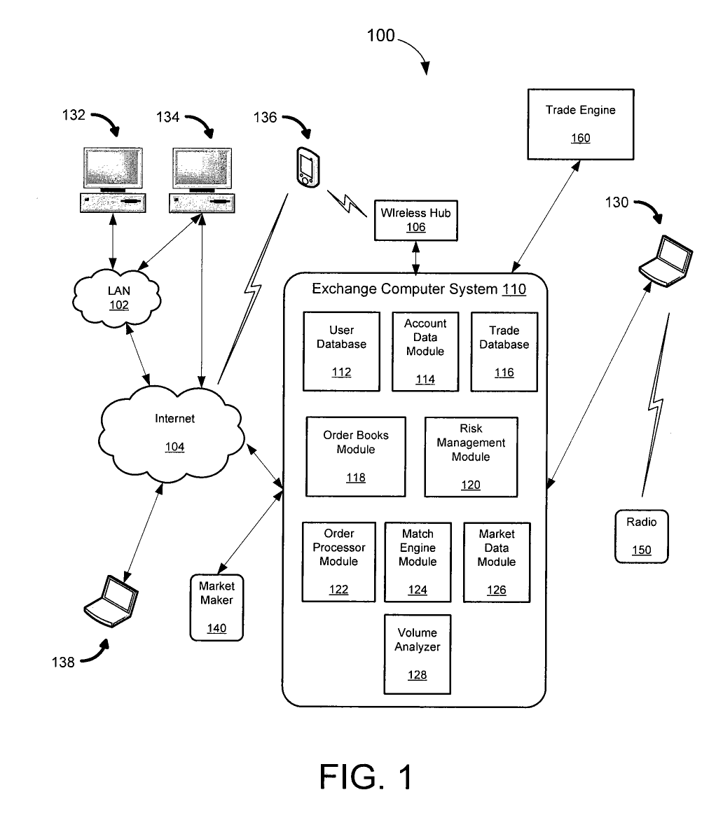

FIG. 1 illustrates one embodiment of a trading network 100 for implementing trading systems and methods. The trading network 100 may include an exchange computer system 110, one or more computer devices 130, 132, 134, 136, and 138, one or more market makers 140, a radio 150, and a trade engine 160. The exchange computer system 110 may be coupled with the computer devices 130-138, the one or more market makers 140, the radio 150, and the trade engine 160. As used herein, the term “coupled with” includes directly connected or indirectly connected through one or more intermediary components. The intermediary components may include networks, hardware, and/or software.

All, some, or none of a trading network 100 may be owned, operated, controlled, or managed by one or more exchanges, such as the Chicago Mercantile Exchange or New York Mercantile Exchange. An exchange may be a central financial exchange where traders can trade standardized financial instruments, such as a contract to buy specific quantities of a commodity, at a specified price. The exchange may be a financial and/or commodity derivative exchange, for example.

The trading network 100 may be a network or other exchange system for placing trades. In other words, the trading network 100 may be used to place and fill orders for contracts, such as outright contracts and spread contracts. In commodities trading, an outright contract is defined by a product and a delivery period, such as a calendar month. A spread contract is defined as the simultaneous purchase and sale of two independent contracts. Although these contracts could themselves be spread contracts, it is more common for them to be outright contracts that cannot be further decomposed. Spread contracts may be a calendar spread between futures contracts for different months and intercommodity spreads between futures contracts in the same month but for different commodities. The bid component and the offer component of a spread are termed the bid leg and the offer leg.

The exchange computer system 110 may be a server, supercomputer, personal computer, central processing system, or other processor that receives and matches orders. The exchange computer system 110 may be owned, managed, controlled, monitored, programmed, sold, or used by an exchange. The exchanges may be a regulated or unregulated exchange or other electronic trading service making use of electronic trading systems. For example, the exchange may include the Chicago Board of Trade (CBOT), the Chicago Mercantile Exchange (CME), the Bolsa de Mercadorias e Futoros in Brazil (BMF), the London International Financial Futures Exchange, the New York Mercantile Exchange (NYMEX), the Kansas City Board of Trade (KCBT), MATIF (in Paris, France), the London Metal Exchange (LME), the Tokyo International Financial Futures Exchange, the Tokyo Commodity Exchange for Industry (TOCOM), the Meff Renta Variable (in Spain), the Dubai Mercantile Exchange (DME), and the Intercontinental Exchange (ICE).

Computer devices 130, 132, 134, 136, and 138 may be personal computers, servers, mobile devices, programmed computing devices, networked computing systems, or other electronic devices that may be used to transmit orders to the electronic trading system 100. The computer devices 130, 132, 134, 136, and 138 may include a central processor that controls the overall operation of the computer and a system bus that connects the central processor to one or more conventional components, such as a network card or modem. Each computer device 130, 132, 134, 136, and 138 may also include a variety of interface units and drives for reading and writing data or files. Depending on the type of computer device, a trader can interact with the computer using an input, such as a keyboard, pointing device, microphone, pen device or other input device. The input may be used for defining a trade.

The one or more of the computer devices 130, 132, 134, 136, and 138 may be used to place an order. The computer devices 130, 132, 134, 136, and 138 may be personal computers, servers, mobile phones, mobile computers, personal digital assistants, wireless device, other electronic device used for placing an order or receiving market data, or any combination thereof. The computer devices 130, 132, 134, 136, and 138 may include a central processor that controls the overall operation of the computer and a system bus that connects the central processor to one or more conventional components, such as a network card or modem. The computer devices 130, 132, 134, 136, and 138 may also include a variety of interface units and drives for reading and writing data or files. Depending on the type of computer device, a user can interact with the computer with a keyboard, pointing device, microphone, pen device or other input device.

Computer device 130 is shown directly connected to exchange computer system 110. Exchange computer system 110 and computer device 130 may be connected via a fiber optic line, such as a T1 line, a common local area network (LAN) or other mechanism for connecting computer devices. Computer device 130 is shown connected to a radio 150. The user of radio 150 may be a trader or exchange employee. The radio user may transmit orders or other data to a user of computer device 130. The user of computer device 130 may then transmit the trade or other data to exchange computer system 110.

Computer devices 132 and 134 are coupled to a LAN 102. LAN 102 may have one or more local area network (LAN) topologies and may use a variety of different protocols, such as Ethernet. Personal computers 132 and 134 may communicate with each other and other computers and devices connected to LAN 102. Computers and other devices may be connected to LAN 102 via twisted pair wires, coaxial cable, fiber optics or other media. Alternatively, a wireless personal digital assistant device (PDA) 136 may communicate with LAN 102 or the Internet 104 via radio waves. PDA 136 may also communicate with exchange computer system 110 via a conventional wireless hub 106. As used herein, a PDA includes mobile telephones and other wireless devices that communicate with a network via radio waves.

LAN 102 may be connected to the Internet 104. LAN 102 may include a router to connect LAN 102 to the Internet 104. Computer device 138 is shown connected directly to the Internet 104. The connection may be via a modem, digital subscriber line (DSL) line, satellite dish or any other device for connecting a computer device to the Internet.

One or more market makers 140 may maintain a market by providing constant bid and offer prices for a derivative or security to exchange computer system 110. Exchange computer system 110 may also exchange data with other trade engines, such as trade engine 160. One skilled in the art will appreciate that numerous additional computers and systems may be coupled to exchange computer system 110. Such computers and systems may include clearing, regulatory and fee systems.

The operations of computer devices and systems shown in FIG. 1 may be controlled by computer-executable instructions stored on computer-readable medium. For example, computer device 132 may include computer-executable instructions for receiving order data from a user and transmitting that order data to exchange computer system 110. In another example, computer device 134 may include computer-executable instructions for receiving market data from exchange computer system 110 and displaying that data to a user.

Numerous additional servers, computers, handheld devices, personal digital assistants, telephones and other devices may also be connected to exchange computer system 110. Moreover, one skilled in the art will appreciate that the topology shown in FIG. 1 is merely an example and that the components shown in FIG. 1 may be connected by numerous alternative topologies.

The exchange computer system 110 may receive an order, for example, via the computer devices 130-138, the market makers 140, and the trade engines 160. The order may be a real order. Real orders are orders that are entered into the system by traders. The trader provides the appropriate data to the trading system and releases the order into the system as an open order. Real orders may be entered for any tradable item in the system including, but not limited to, futures, options, inter-commodity spreads, intra-commodity spreads, futures strips, and so forth.

The exchange computer system 110 may calculate an implied order on the behalf of traders who have entered real orders. For example, an implied spread may be derived from two real outrights. The exchange computer system 110 calculates the implied order and displays its price level and available volume in the appropriate contract. This is sometimes referred to as an implied market rather than an implied order on the understanding that a given price level may include more than one actual order at the same price. If a trader enters a real order to trade against the implied order, then the input order and the real orders that are combined to create the implied order all receive fills, with the buys and sells in each leg being reported as matched trades.

Implied orders may have better prices than the corresponding real orders in the same contract. This can occur when two or more traders incrementally improve their order prices in hope of attracting a trade. Combining the small improvements from two or more real orders can result in a big improvement in the implied order. Advertising implied orders at better prices will encourage traders to enter the opposing orders to trade with them. The more combinations that the match engine 124 can calculate, the greater this encouragement will be and the more the exchange will benefit from increased transaction volume. However, as the number of advertised orders increases, so does the time required to calculate and publish them as market data. The match engine may implement a calculation policy that limits the calculation of implied markets or a publication policy that limits the publication of implied markets that have been calculated. An example of a technique for defining implicable contracts and the calculation of implied markets can be found in U.S. patent application Ser. No. 12/032,379, which is incorporated herein by reference in its entirety. An example of a technique for calculating implied orders subject to a calculation policy or publication policy is given in U.S. patent application Ser. No. 12/350,788, which is incorporated herein in its entirety.

Exchange computer system 110 may be implemented with one or more mainframes, servers, desktops, or other computers. The exchange computer system 110 may include or have access to one or more databases, such as a user database 112 that includes data identifying traders and other users of exchange computer system 110. Data may include user names and passwords. An account data module 114 may process account data that may be used during trades. A trade database 116 may be included to store data identifying trades and descriptions of trades. In particular, a trade database may store data identifying the time that a trade took place and the contract price. An order book module 118 may be included to compute or otherwise determine current bid and offer prices. A risk management module 120 may be included to compute and determine a user's risk utilization in relation to the user's defined risk thresholds. An order processing module 122 may be included to decompose delta based and bulk order types. A match engine module 124 is included to match bid and offer prices. Match engine module 124 may be implemented with software that executes one or more algorithms for matching bids and offers. A market data module 126 may be included to collect market data and prepare the data for transmission to users. The implied volume analyzer 128 may identify available implied patterns, which were not calculated by the match engine 124, for example, based on market data provided from the match engine module 124 and/or the market data module 126. As used herein, the term “based on” may include as a function of, using, or depending on.

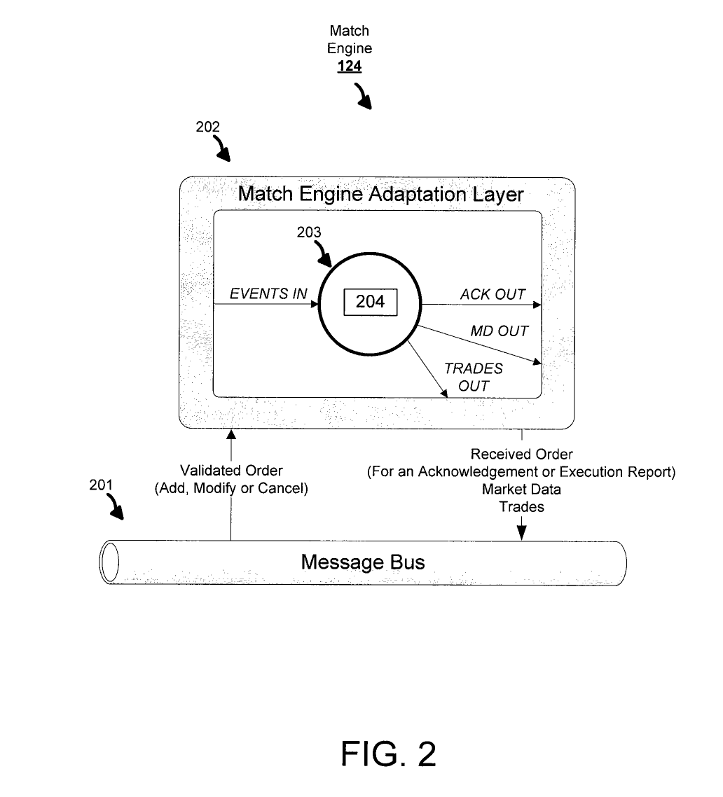

FIG. 2 illustrates one embodiment of the match engine module 124. Electronic trading systems in major exchanges are typically implemented with distributed architectures, with the order matching function being performed by a specialized component referred to as the match engine module 124 (hereinafter, match engine 124). Although FIG. 1 is simplified to show only one match engine 124, the electronic trading system 110 may have one or more match engines 124. Each match engine 124 is a specialized order matching component that receives orders, stores them internally, calculates tradable combinations and advertises the availability of real and implied orders in the form of market data. When the traders using the system respond to the market data by sending additional orders, these are received by the match engine 124, which then attempts to match them with previously received orders or combinations thereof The match engine 124 executes the possible trades and communicates the results.

The operations of the match engine 124 may be performed in more than one part of the trading network 100 or in related systems. For example, the calculation of implied orders may be done by traders at their trading stations in search of arbitrage opportunities between trading networks or match engines. It is also possible to perform these calculations outside a trading network for the evaluation of possible trading strategies, for instruction, regulation or in the solution of other problems where trading is used as a model.

Implication is a liquidity spreading technique, which is typically, but not necessarily, implemented in a sub-component of the match engine 124 called the implicator 204. Implication makes use of orders in spread contracts to spread liquidity amongst outright contracts, a technique discussed in more detail below. The match engine 124 may have a layered architecture. The match engine 124 communicates with other components using a message bus 201. Incoming messages are translated by an adaptation layer 202 into events that can be processed by a match engine core 203, sometimes referred to simply as the core. The output messages from the core 203 are translated by the adaptation layer 202 back into messages that can be transmitted to other parts of the trading system using the message bus 201. The implicator 204 may be program code that calculates implied orders. Although this example shows the implicator 204 as part of the match engine 124 in an electronic trading system, the implicator 204 may be used in any system where implied orders need to be calculated. An example of such a system is the client software used by a trader to receive market data and search for arbitrage opportunities on multiple electronic trading systems.

The implicator 204 operates on a group of tradable instruments referred to as an implication group. In an implementation for futures trading, an implication group consists of outright contracts and combination contracts that can trade with each other. An outright contract is defined by a product and a delivery period. A combination contract is defined by two or more outright contracts which are referred to as legs. The simplest of these combination contracts is the calendar spread, which is a contract to buy a product in one delivery period and sell it in another. Another simple combination contract is the intercommodity spread, which is a contract to buy one product in a delivery period and sell another product in the same delivery period. The simplest possible implication group consists of two outrights and the spread between them. It is understood that implication groups may be of arbitrary size and that combination contracts may be defined in terms of other combination contracts so long as all of the required legs are present in the implication group. It is understood that the concepts of outright and combination are applicable to a wide range of tradable instruments. It is understood that the product code given without a specific delivery month is a convenient shorthand for all of the contracts in that product or for an arbitrary contract used as an example, depending on the context. It is understood that the year may be omitted if the context makes it clear that a month-of-the-year is being used in the example rather that a specific date.

The match engine core 203 and/or the implicator 204 may be implemented in a programming language such as Java or C++ that allows multiple threads of execution and that a program with multiple threads may be executed on a computing system with multiple central processing units (CPU). In such an implementation, if the program is correctly designed, the threads will execute in parallel and the time taken to execute all of the threads can be as short as the time taken by the single longest thread. If there are more threads than CPUs, then the execution time will depend on how many threads must be executed sequentially on each CPU. In FIG. 2, it is contemplated that the core 203 will be implemented in such a language and that the calculation of implied orders by the implicator 204 will be accelerated by performing many independent calculations in parallel on separate threads.

When there are different trading units, currencies or other factors affecting the price, the adaptation layer 202 may associate external trading system prices in units like barrels and gallons with machine prices in scaled units that are internal to the Match Engine core 203 and common to all the contracts in the implication group. When ratio spreads are used to connect contracts with different volume units or size specifications, the adaptation layer 202 may also associate external quantities with internal scaled units that are also internal to the match engine core 203 and common to all the contracts in the implication group.

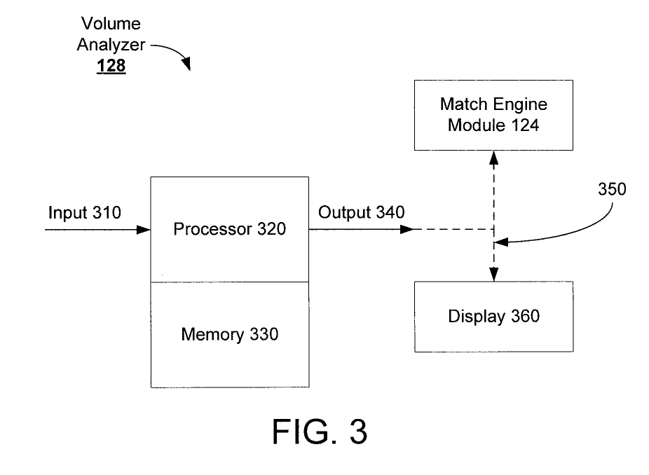

FIG. 3 illustrates one embodiment of the volume analyzer 128. The volume analyzer 128 may include an input 310, processor 320, memory 330, and output 340. Additional, different, or fewer components may be provided in the volume analyzer 128. For example, the display 360 may be a part of the volume analyzer 128. Alternatively, the display 360 may be in communication with but independent of the volume analyzer 128.

The processor 320 may be coupled with the input 310, memory 330, and/or output 340. The volume analyzer 128 may be operable to receive market data and one or more match engine calculation policies, identify an available implied pattern based on the market data and the one or more match engine calculation policies, and output the available implied pattern.

In one embodiment, the volume analyzer 128 is integrated into the exchange computer system 110, for example, sharing processor 320 with one, some, or all of the modules of the exchange computer system 110. In an alternative embodiment, the volume analyzer 128 may operate independently of one, some, or all of the modules of the exchange computer system 110. For example, the volume analyzer 128 may operate on a personal computer and the other modules may operate on a central server.

The input 310 may be a user input, network interface, external storage, or other input device for providing data to the volume analyzer 128. For example, the input 310 may be a mouse, keyboard, track ball, touch screen, joystick, touch pad, buttons, knobs, sliders, combinations thereof, or other now known or later developed user input device. The user input may operate as part of a user interface. For example, one or more buttons may be displayed on a display. The user input is used to control a pointer for selection and activation of the functions associated with the buttons. Alternatively, hard coded or fixed buttons may be used. As another example, the input 310 is a hard-wired or wireless network interface. A universal asynchronous receiver/transmitter (UART), a parallel digital interface, a software interface, Ethernet, or any combination of known or later developed software and hardware interfaces may be used. The network interface may be linked to various types of networks, including a local area network (LAN), a wide area network (WAN), an intranet, a virtual private network (VPN), and the Internet.

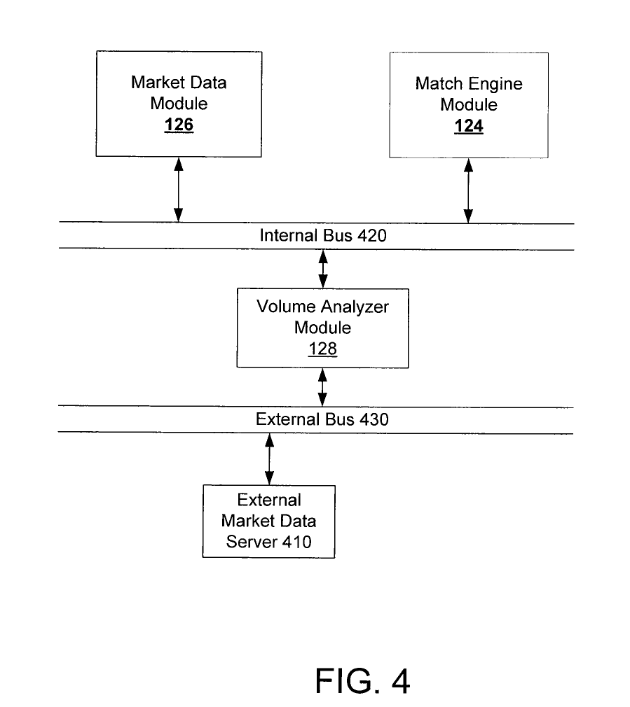

The input 310 may be an interface to receive data. The data may be market data. As shown in FIG. 4, the volume analyzer module 128 may be operable to receive market data from the match engine 124, the market data module 126, and an external market data server 410. The volume analyzer 128 may receive market data from the match engine 124 and/or market data module 126 via an internal bus 420 and from the external market data server 410 via an external bus 430. The match engine 124 and/or market data module 126 may be operable to transmit market data relating to a trading session supported by the exchange computer system 110. In other words, the market data may be internal market data. The external market data server 410 may operate in conjunction with or independently of an external exchange system. The external exchange system may be operated, managed, controlled, or owned by the same or a different Exchange as the Exchange operating, managing, controlling, or owning the exchange computer system 110. For example, in one embodiment, the external market data server 410 may be operated by the New York Mercantile Exchange and the exchange computer system 110 may be operated by the Chicago Mercantile Exchange. The external bus 430 may be used to import market data from the New York Mercantile Exchange. The internal bus 420 and external bus 430 may be secured in order to prevent unauthorized use of the market data. The internal bus 420 and external bus 430 may be the same bus or different buses.

Referring again to FIG. 3, the input 310 may be an interface to receive one or more match engine calculation policies. A match engine calculation policy may be a set of one or more rules, guidelines, or instructions that determines the implied patterns that will be or have been calculated by the match engine 124 or which might be calculated at some future time based on the outcome of a feasibility study, data analysis or similar process. A match engine calculation policy may be defined by the exchange system to maximize profits, for example, by providing a fast matching system. As a result, the one or more match engine calculation policies may determine a subset of all the possible implied patterns that could be calculated. The subset may be defined by the exchange.

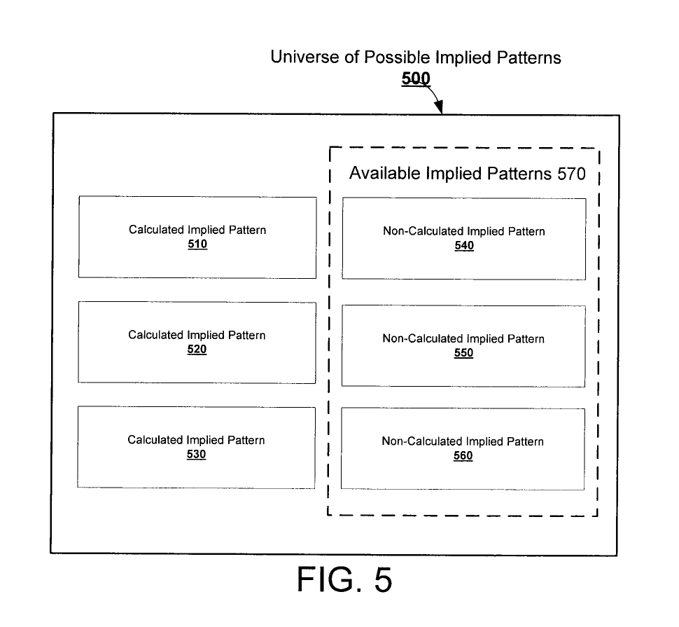

The input 310 may be an interface to receive one or more calculation policies that determine a universe of possible implied patterns, also referred to as an available calculation policy because it will be used to determine the implied patterns that are available in principle but not actually calculated by a given match engine. The available calculation policy may be a set of one or more rules, guidelines, algorithms, or instructions that determines a group of available implied patterns for a given set of market data. As shown in FIG. 5, the universe of possible implied patterns 500 may include implied patterns calculated by the match engine 124 and available implied patterns. The group of universe of possible implied patterns 500 may be all, some, or none of the implied patterns available based on the market data. In other words, the universe of possible implied patterns 500 may be the entire group of implied patterns that could be calculated based on the market data.

The processor 320 is operable to determine the available implied patterns as a function of a universe of possible implied patterns 500 and identifying the non-calculated implied patterns 540, 550, 560. Identifying the non-calculated implied patterns 540, 550, 560 may include recognizing and removing, discarding, ignoring, or not using the match engine calculated implied patterns 510, 520, 530. Recognizing the calculated implied patterns 510, 520, 530 may include processing market data using the one or more calculation policies to determine the implied patterns that the match engine 124 calculated. The calculated implied patterns 510, 520, 530 may be compared to the universe of possible implied patterns 500 to determine which of the implied patterns in the universe 500 are calculated implied patterns and determine which of the implied patterns in the universe 500 of non-calculated implied patterns. The non-calculated implied patterns 540, 550, 560 may be referred to as available implied patterns 570.

The available implied patterns 570 may be missed opportunities for the Exchange. In other words, the available implied patterns 570 are implied patterns that were not calculated by the match engine 124; and thus, were not made available to traders. As a result, an outright order may not have been matched as quickly as it could have been or not matched at all. Additionally, in the event that implied markets in the available implied patterns 570 had been published, a trader may have placed an additional order or bid at a contract price and this would have resulted in additional commission fees for the Exchange.

The processor 320 may transmit the available implied patterns 570 via the output 340 or may transmit the existence of implied markets in one or more of these patterns. The output 340 may be an interface to a network 350 that is coupled with the match engine 124 and/or a display 360. In one embodiment, the network 350 may include the internal bus 420 and/or external bus 430. In another embodiment, the network 350 may include a communication network, such as a local area network, wireless network, or other network or channel for transmitting data. The network 350 may utilize the Internet, for example, using the Internet Protocol/Transmission Control Protocol. Other communication protocols may be used.

In one embodiment, the available implied patterns 570 may be transmitted to the match engine 124. The design of the match engine 124 may be based on available implied patterns 570 or on implied markets within these patterns. In other words, the design of the match engine 124 may be adjusted to begin calculating the available implied patterns 570 and making the available implied patterns 570 available to traders. Alternatively, the match engine 124 may be adjusted to begin calculating specific implied markets that occur within one or more implied patterns

In another embodiment, the available implied patterns 570 or the volume available for trading in specific implied markets within these patterns may be displayed on a display 360. The display 360 is a cathode ray tube (CRT) device, liquid crystal display (LCD), plasma, projector, monitor, printer, or other output device for showing data. The display 360 is operable to display an image. The image may be an image of one or more implied markets or available implied patterns 570. The image may include text, graphics, video, or other representations of the one or more available implied patterns 570. For example, in one embodiment, the image includes a representation of an implied pattern. The representation may include one or more tradable products, traces connecting the tradable products (e.g., the traces may represent spreads or other combination contracts), the price (e.g., $/contract), the time that the implied contract was available for trading (e.g., milliseconds), the volume of the implied pattern (e.g., in lots), or any combination thereof. Other representations may be used.

The processor 320 has any suitable architecture, such as a general processor, central processing unit, digital signal processor, application specific integrated circuit, field programmable gate array, digital circuit, analog circuit, combinations thereof, or any other now known or later developed device for processing data. Likewise, processing strategies may include multiprocessing, multitasking, parallel processing, and the like. A program may be uploaded to, and executed by, the processor 320. The processor 320 implements the program alone or includes multiple processors in a network or system for parallel or sequential processing.

The processor 320 operates pursuant to instructions. The instructions, available implied patterns, one or more match engine calculated implied patterns, and one or more calculation policies, one or more available implied pattern calculation policies, or other data may be stored in the memory 330. The memory 330 may be computer-readable storage media or other memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination.

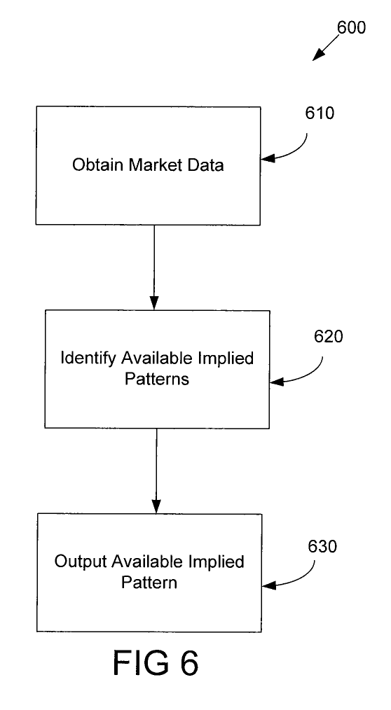

FIG. 6 illustrates one embodiment of a method 600 for identifying available implied patterns. The method 600 may include obtaining market data 610, identifying available implied patterns 620, and outputting available implied patterns 630. The method 600 may include additional, different, or fewer acts. The acts may be performed in the order shown or a different order.

In act 610, volume analyzer obtains market data. The market data may be received via the internal bus 420 or the external bus 430. In one example, the market data is received from a match engine 124 that publishes market data. The match engine 124 may stream the market data to the volume analyzer 128 in real-time. In another example, market data is stored and delivered to the volume analyzer 128 after storage. The market data may include data about one or more outright orders or implied orders, such as calculated implied patterns 510, 520, 530. Additionally or alternatively, the market data may include data about matches performed by the match engine 124. In act 620, the volume analyzer 128 identifies available implied patterns. The available implied patterns may be one or more implied patterns that were not calculated by the match engine 124.

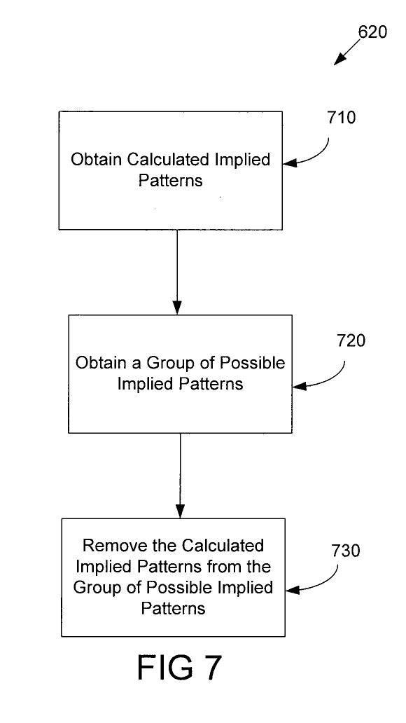

FIG. 7 illustrates one embodiment of a method that may be performed for act 620. In act 710, the volume analyzer 128 may obtain calculated implied patterns 510, 520, 530. The volume analyzer 128 may obtain the calculated implied patterns 510, 520, 530 by using one or more calculation policies used by the match engine 124. The one or more calculation policies may be obtained, for example, received or read, from the match engine or a database. The market data, for example, obtained in act 610, may be processed with the one or more calculation policies to determine the calculated implied patterns 510, 520, 530. In act 720, the volume analyzer 128 may obtain a group of possible available implied patterns. Obtaining the group of available implied patterns may include calculating, for example, using one or more available calculation policies, all, some, or none of the implied patterns that are available based on the received market data. In act 730, the volume analyzer 128 may remove the calculated implied patterns 510, 520, 530 from the group of available implied patterns. Removing the calculated implied patterns 510, 520, 530 may include deleting, discarding, not using, separating, or a combination thereof. The volume analyzer 128 may compare the group of available implied patterns to the calculated implied patterns 510, 520, 530 to determine the non-calculated implied patterns. The non-calculated implied patterns may be referred to as the available implied patterns. The acts shown in FIG. 7 may be performed in the order shown or a different order. For example, act 710 may be performed after act 720.

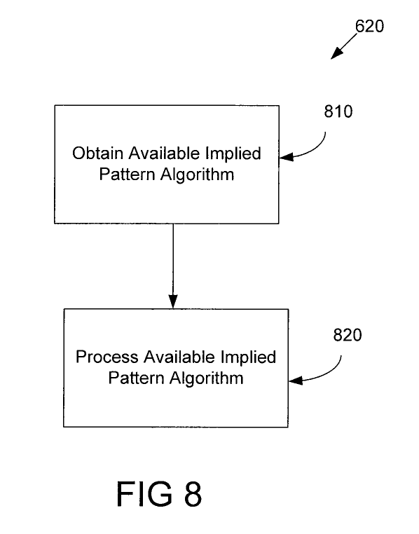

FIG. 8 illustrates another embodiment of a method that may be performed to identify available implied patterns. In act 810, the volume analyzer 128 may obtain one or more available implied pattern algorithms. The algorithm may be stored in memory. The algorithm may be a data analysis algorithm. The algorithm may be an algorithm for analyzing market data and determining one, some, or all of the implied patterns available in the market data. In act 820, the volume analyzer 128 may process the available implied pattern algorithm to identify one, some, or all of the implied patterns available in the market data. As the market data changes, the algorithm may identify new available implied patterns. The available implied pattern algorithm may be used to distinguish available implied patterns, which were not calculated by the match engine 124, from those implied patterns that were calculated by the match engine 124.

In act 630, as shown in FIG. 6, the volume analyzer 128 may output available implied patterns and their associated properties, such as the volume available in implied markets calculated according to the pattern, either individually, as an aggregate totals or subtotals or some combination thereof. Outputting the available implied patterns may include transmitting the available implied patterns and their properties to the match engine 124, displaying the available implied patterns and their properties on a display, storing the available implied patterns and their properties in memory, or a combination thereof. The match engine may be designed, based on the available implied patterns and their properties identified by the volume analyzer 128, to compute implied markets according to these patterns and to make these implied markets available to traders.

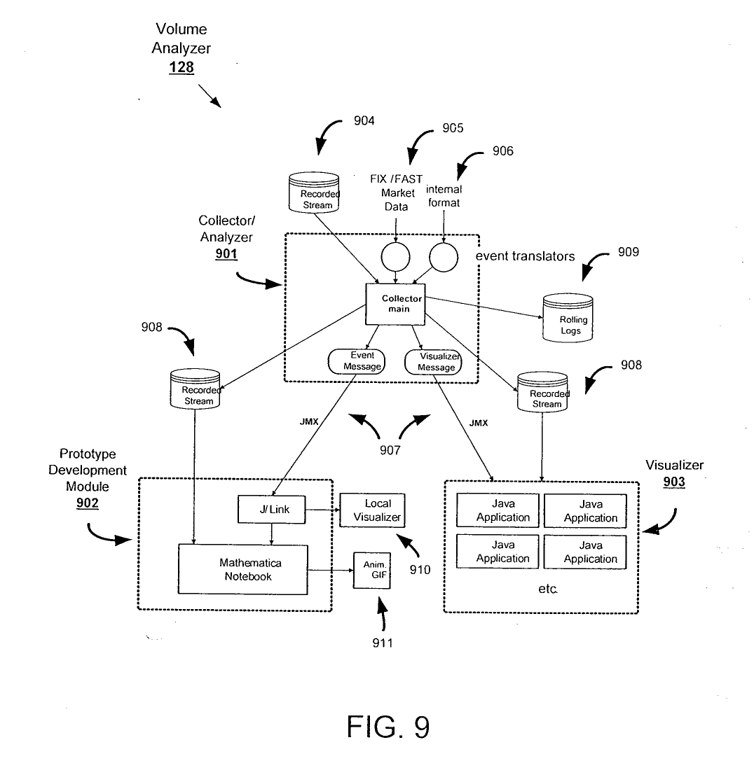

FIG. 9 illustrates one embodiment of an implied volume analyzer 128 as it might be deployed as a component in the exchange computer system 110 of FIG. 1. The implied volume analyzer 128 may include a collector/analyzer 901, a prototype development module 902, and a visualizer 903. The visualizer 903 may include one or more application programs. Additional, different, or fewer components may be provided. The components may be part of the same or different processing machines.

The collector/analyzer 901 may receive market data. The market data may be received as a recorded stream 904, for example, from an internal or external match engine. The recorded stream may be a stream of market data that is being published in real-time or at a delayed rate. The market data may be received as FIX/FAST market data 905, for example, from a market data module. The market data may be received in an internal format 906 as it is output by the match engine module. Receiving market data may include collecting, gathering, or requesting the market data. The collector/analyzer 901 may include one or more event translators for converting market data in one of the preceding formats into data that can be used by its methods of implication. The collector/analyzer 901 outputs data representing available implied patterns or other data of interest in the form of event messages 907, for example using the Java Management Extensions (JMX) message format. These event messages are received by the prototype development module 902 and the visualizer 903. The collector/analyzer 901 may record its event messages in a files 908 for later analysis, for example to play back a trading session outside of normal trading hours. The collector/analyzer 901 may also record data in log files 909.

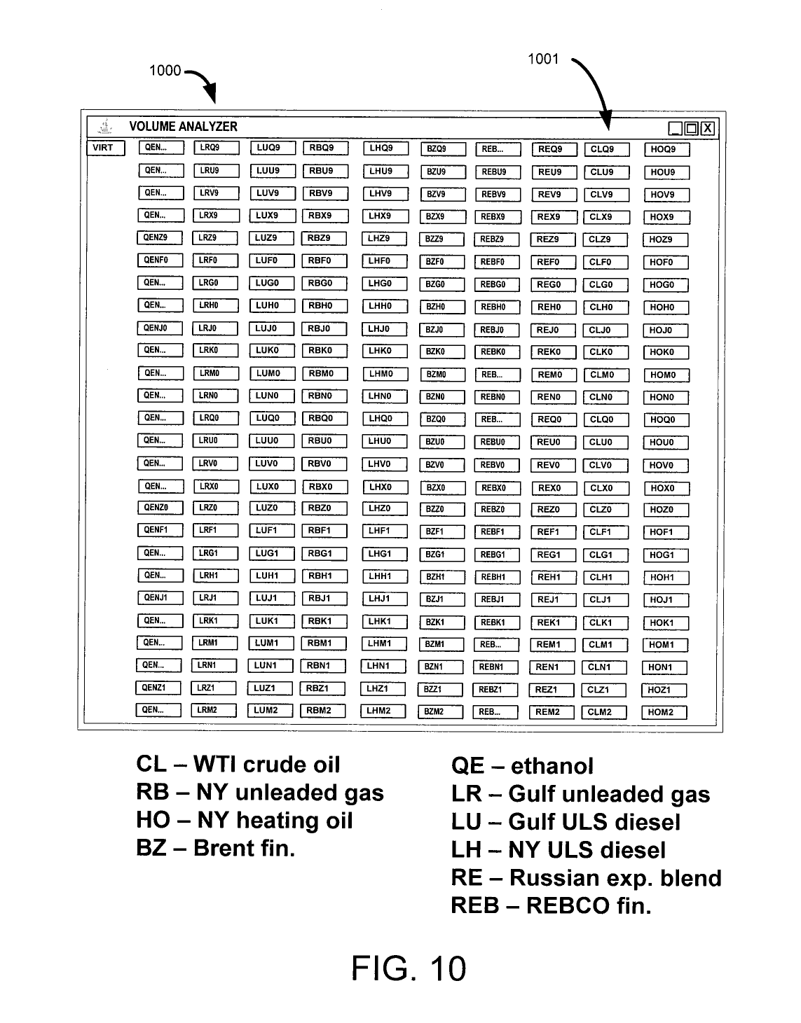

FIG. 10 illustrates one embodiment of receiving and displaying events at a visualizer 1000 in a graphical user interface. The events may be oil cluster arbitrage opportunities and the contracts involved may be outrights and spreads in ten different products (e.g., CL, RB, HO, BZ, QE, LR, LU, LH, RE, and REB) and 26 delivery months. It is understood that FIG. 10 shows a window implemented with techniques familiar to those of skill in the art and that elements of the display such as the rectangle 1001 representing outright contract CLQ9 may be selected, repositioned on the display, receive changed properties through a menu and so forth. The events that the visualizer 1000 uses to create its display are referred to as the output representation of the collector/analyzer.

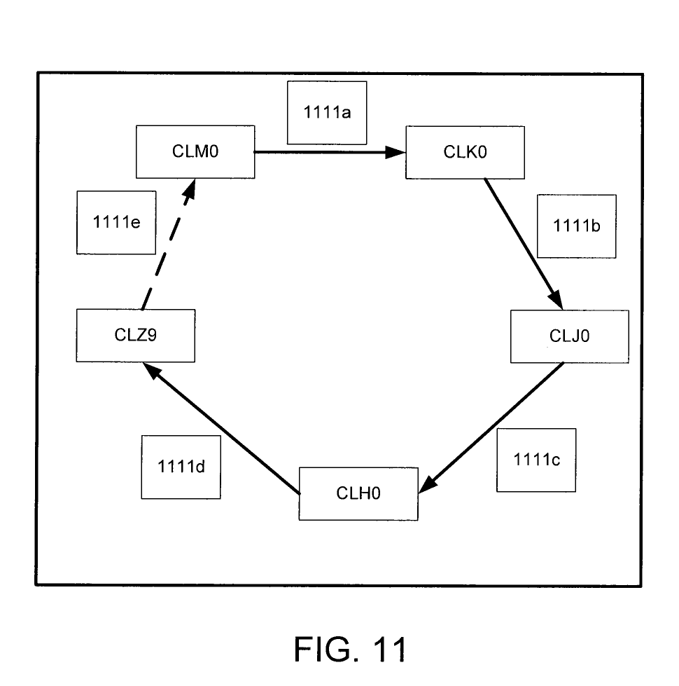

The output representation may include a description of the available implied pattern or associated data. The description may be a textual description, a graphical description, a combination thereof, or other description. FIG. 11 illustrates one embodiment of an output representation as it is displayed by the visualizer 1000. As shown in FIG. 11, each contract has a graphical representation. The graphical representation is an arrow (e.g., solid line=sell; dotted line=buy). The arrows connect two different contracts that could be bought and sold. Each contract includes a textual description 1111a-e. The textual descriptions may include the cost, time of identification, or size.

Referring back to FIG. 9, the prototype development module is operable to calculate implied markets using algorithms of potential interest to the designers of the match engine or the operators of the computer exchange system. The prototype development module may also be used to investigate other aspects of the market data or other recorded data streams so that appropriate data analysis code can be deployed to the collector/analyzer 901 where it can be executed at greater speed or with greater convenience. Additionally, the prototype development module may provide data to a local visualizer 910 or create animated GIF files 911 so that alternative visualizations of the output representation can be discussed with users before creating more robust visualization code that can be deployed to visualizers.

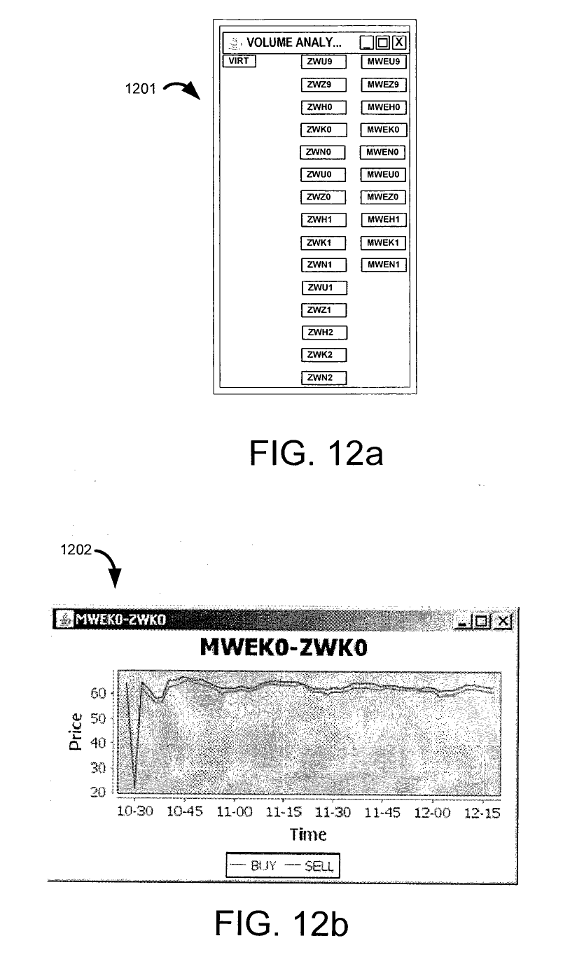

The visualizer 1000 may be a display that is operable to display the output representation. The visualizer 1000 may be operable to run a script (e.g., computer program executable on a computer) to continually receive available implied patterns. It is possible to define visualizers for any type of trading system data where observation in real time by human observers can provide useful insights. For example, FIG. 12a and FIG. 12b show windows displayed by a visualizer 1000 for implied spreads between Minneapolis Hard Red Spring Wheat MWE and Chicago Board of Trade (CBOT) Wheat ZW. The window 1201 shows the products and delivery months involved in the analysis and window 1202 shows a plot of the implied buy and sell prices for the MWEK0-ZWK0 (May 2010) spread. The spreads had not yet been implemented in the trading system and observation of the price volatility and the size of the bid/ask spread provided the operators of the trading system 100 with useful information on how the spreads might ultimately behave.

Each visualizer 1000 or part of a visualizer may be implemented as a separate Java application. Referring back to FIG. 9, an analyst may have a collection of Java applications, each of which may provide a different view of events from one or more collector/analyzers. Those of skill in the art will appreciate that Java applications may be deployed in the form of runnable Java archive (JAR) files that a Java Management Extensions (JMX) client can be configured to receive events of a specific type from a specific collector and that more than one JMX client can subscribe to the same event stream. The user of a visualizer 1000 may have more than one computer available for running applications and the tasks of visualization may be distributed amongst these computers in such a way that the viewing experience is helpful and not fatiguing to the human observer.

Various improvements described herein may be used together or separately. Any form of data mining or searching may be used. Although illustrative embodiments have been described herein with reference to the accompanying drawings, it is to be understood that the invention is not limited to those precise embodiments, and that various other changes and modifications may be affected therein by one skilled in the art without departing from the scope or spirit of the invention.

1. A volume analyzer comprising:
an input operable to receive market data and a calculation policy;
a processor coupled with the input, the processor being operable to identify an available implied pattern based on the market data and the calculation policy, the available implied pattern having not been calculated by a match engine; and
an output coupled with the processor, the processor being operable to provide the available implied pattern to the output.

2. The volume analyzer of claim 1, wherein the processor is operable to determine the available implied pattern using data analysis.

3. The volume analyzer of claim 1, wherein the calculation policy is a match engine calculation policy that a match engine uses to determine one or more match engine calculated implied patterns, the one or more match engine calculated implied patterns being removed from a group of available implied patterns to determine the available implied pattern.

4. The volume analyzer of claim 1, wherein the processor is operable to use a volume analysis algorithm to identify the available implied pattern.

5. The volume analyzer of claim 1, wherein the input is operable to receive market data from an internal bus or external bus, the internal bus being coupled with a match engine that is operable to perform internal trade matching and the external bus being coupled with a market data server that is operable to perform external trade matching.

6. The volume analyzer of claim 1, wherein the output is operable to display the available implied pattern on a display or transmit the available implied pattern to a match engine.

7. The volume analyzer of claim 1, wherein the available implied pattern is an implied pattern that could have been calculated by a match engine but was not calculated by the match engine.

8. A method for analyzing implied volumes, the method comprising:
receiving market data and at least one calculation policy;
identifying a non-utilized implied pattern based on the market data and the calculation policy, the non-utilized implied pattern having an implied pattern volume that satisfies a volume level; and
outputting the non-utilized implied pattern.

9. The method as claimed in claim 8, wherein identifying includes determining an implied pattern volume for the non-utilized implied pattern based on the market data and determining whether the implied pattern volume satisfies the volume level using the calculation policy.

10. The method as claimed in claim 9, further comprising comparing the implied pattern volume to the volume level, the implied pattern volume being a number of lots traded or number of ticks for the non-utilized implied pattern and the volume level being a predetermined number of lots that provide sufficient revenue.

11. The method as claimed in claim 8, wherein receiving market data includes receiving market data from an internal bus or external bus, the internal bus being coupled with a match engine that is operable to perform internal trade matching and the external bus being coupled with a market data server that is operable to perform external trade matching.

12. The method as claimed in claim 8, wherein receiving at least one calculation policy includes reading the at least one calculation policy from a computer readable storage media.

13. The method as claimed in claim 8, wherein outputting includes displaying the non-utilized implied pattern.

14. The method as claimed in claim 8, wherein outputting includes transmitting the non-utilized implied pattern to a match engine that is operable to adjust published market data based on the non-utilized implied pattern, where adjusting published market data includes making the non-utilized implied pattern available to traders.

15. A system comprising:
a bus system operable to transmit and receive market data;
a memory operable to store a calculation policy;
a volume analyzer coupled with the bus system and memory, the volume analyzer operable to:
obtain market data from the bus system and the calculation policy from the memory,
identify a non-utilized implied pattern based on the market data and the calculation policy, the non-utilized implied pattern having an implied pattern volume that satisfies a volume level, and
output the non-utilized implied pattern to the bus system or memory.

16. The system as claimed in claim 15, wherein the volume analyzer is operable to determine an implied pattern volume for the non-utilized implied pattern based on the market data and determine whether the implied pattern volume satisfies the volume level using the calculation policy.

17. The system as claimed in claim 16, wherein the calculation policy is a set of rules that uses market data to determine whether an implied pattern volume satisfies a volume level.

18. The system as claimed in claim 15, wherein the volume analyzer is operable to compare the implied pattern volume to the volume level, the implied pattern volume being a number of lots traded or number of ticks for the non-utilized implied pattern and the volume level being a predetermined number of lots that provide sufficient revenue.

19. The system as claimed in claim 15, wherein the volume analyzer is operable to receive market data from an internal bus or external bus, the internal bus being coupled with a match engine that is operable to perform internal trade matching and the external bus being coupled with a market data server that is operable to perform external trade matching.

20. The system as claimed in claim 15, wherein the volume analyzer is operable to read the calculation policy from the memory, the memory being computer readable storage media.

21. The system as claimed in claim 15, wherein the volume analyzer is operable to transmit the non-utilized implied pattern to a match engine that is operable to adjust published market data based on the non-utilized implied pattern, where adjusting published market data includes making the non-utilized implied pattern available to traders.

22. A device comprising:
means for receiving market data and at least one calculation policy;
means for identifying a non-utilized implied pattern based on the market data and the calculation policy, the non-utilized implied pattern having an implied pattern volume that satisfies a volume level; and
means for outputting the non-utilized implied pattern.

23. The device as claimed in claim 22, further comprising means for receiving market data from an internal bus or external bus, the internal bus being coupled with a match engine that is operable to perform internal trade matching and the external bus being coupled with a market data server that is operable to perform external trade matching.

24. The device as claimed in claim 23, further comprising means for transmitting the non-utilized match engine and adjusting published market data based on the non-utilized implied pattern, where adjusting published market data includes making the non-utilized implied pattern available to traders.

25. The device as claimed in claim 24, further comprising means for outputting the non-utilized implied pattern to a bus system.

26. The device as claimed in claim 24, further comprising means for determining an implied pattern volume for the non-utilized implied pattern based on the market data and determining whether the implied pattern volume satisfies the volume level using the calculation policy.

27. The device as claimed in claim 24, further comprising means for comparing the implied pattern volume to the volume level, the implied pattern volume being a number of lots traded or number of ticks for the non-utilized implied pattern and the volume level being a predetermined number of lots that provide sufficient revenue.
